(19) United States
(12) Patent Application Publication
(10) Pub. No.: US 2021/0005115 A1
(43) Pub. Date: Jan. 7, 2021

(54) Fastener Device System to Affix Signs On Vehciles.

(71) Applicant: Wayne Johnson, Wheaton, IL (US)

(72) Inventor: Wayne Johnson, Wheaton, IL (US)

(21) Appl. No.: 16/460,558

(22) Filed: Jul. 2, 2019

(51) Int. Cl. G09F 7/18; B60R 13/00; F16B 2/06; G09F 21/04

(52) U.S. Cl. CPC G09F 7/18; B60R 13/00; G09F 2007/1865; G09F 21/04; F16B 2/065

(57) ABSTRACT

A sign display attachment system for attaching signs to vehicle(s):

This invention contemplates a non-blemishing, quickly deployed, signage display attachment system that comprises a C-clamp hanger assembly.

The C-clamp hanger assembly has at least two threaded-hole(s) at the top with screws to torque-down into the roof's rain-gutter. This rain-gutter is typically found running along the roof of most vans and some vehicles. The inventor's system ultimately allows for securely anchored signage to be mounted using a screw, hex-nut and the sign's grommet(s) to hang securely to the C-clamp assembly.

The C-clamp style hanger, in tandem with shock cords. (aka, “Bungee cords”) is used to securely fasten large and small format, flexible or rigid, banners and signs on vans and other moving vehicles.

### SUMMARY OF THE INVENTION

The subject, C-clamp style hanger invention, is used to securely fasten large and small format, flexible or rigid, banners and signs on vans and other moving vehicles, with quick installation and removal. Facilitating stunning full-color eye-level notices and advertising, at any rate of speed.

### BACKGROUND OF THE INVENTION

The inventor conceived the class 40/607.12 clamp for contemporaneous use in tandem class 40/591, automotive vehicle carried sign, and has been in continuous use since, circa 2008.

### BRIEF DESCRIPTION OF THE DRAWINGS

FIG. 1 is an isometric view of the C-clamp hanger, excluding other parts.

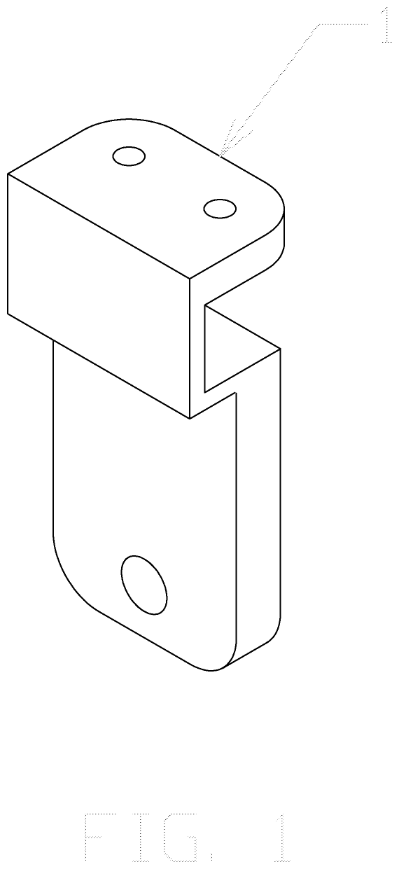

FIG. 2 is a front view of the C-clamp hanger assembly.

FIG. 3 is a side view of the C-clamp hanger assembly with sign and vehicle shown.

FIG. 4 shows putative embodiment No. 2, which is a side view of a slightly-modified, C-clamp hanger assembly. This design clamps onto the rain-gutter of the vehicle with an un-threaded rod-piece applying the requisite torque to secure the hanger to the gutter.

### DETAILED DESCRIPTION

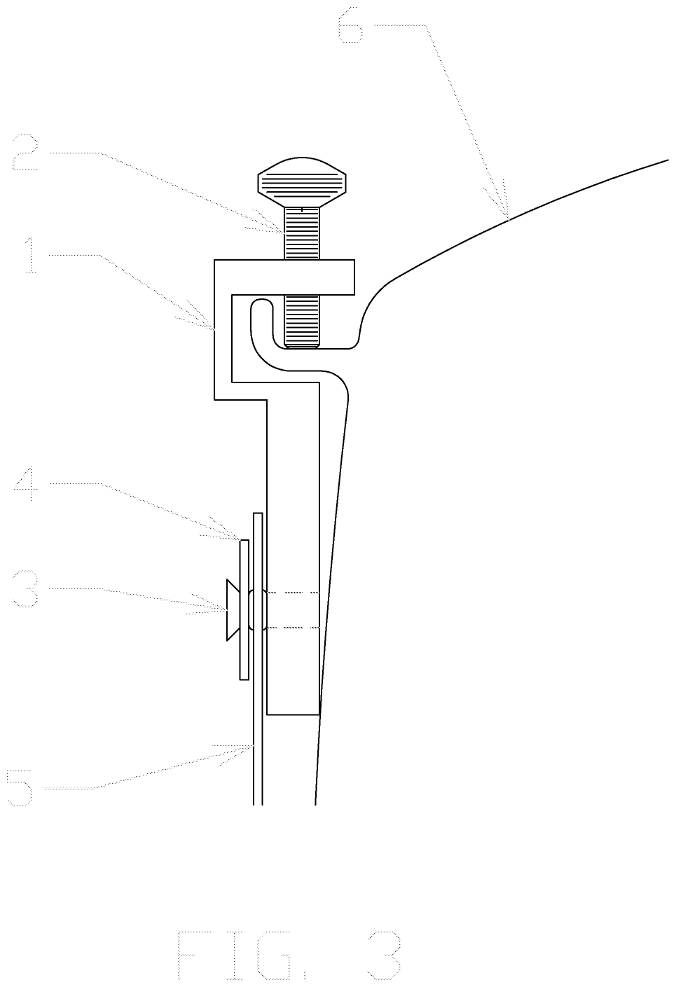

Referring to FIG. 3, the first embodiment of the present invention is shown. A flexible or rigid sign (5) is held in place on the side of the vehicle (6), once the C-clamp hanger assembly is mounted on the rain-gutter, which typically runs around the outer-rim roof of the vehicle.

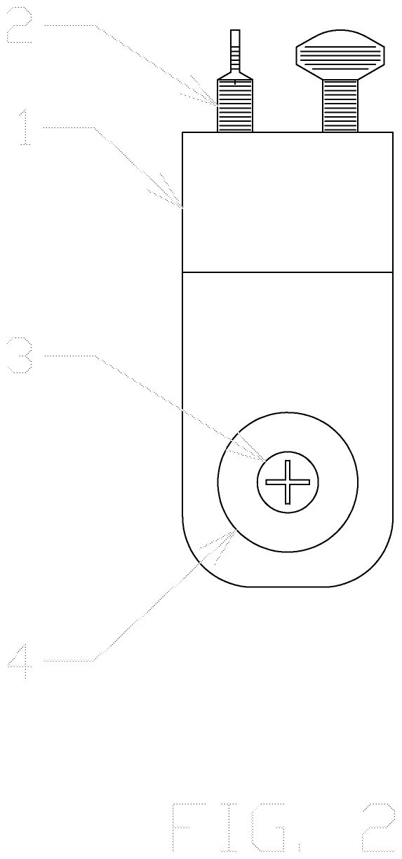

FIG. 2, shows C-clamp (1) front view of where it fastens to the rain-gutter, vehicle not shown. The washer used is illustrated at (4) and screw (3) used to feed-thru sign grommets, is fastened to the lowest point of the C-clamp (1).

FIG. 3, shows a side-view of the mounted signage (5) as it would look once mounted on the vehicle's rain-gutter (6).

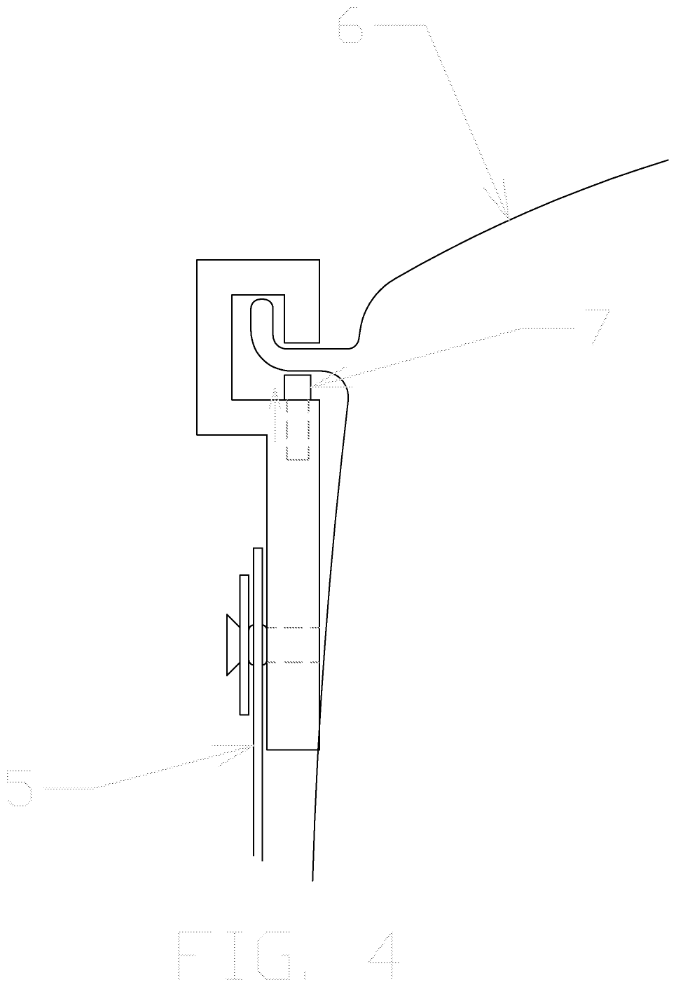

The system's second (2d) embodiment is illustrated at FIG. 4, also in a mounted status. This embodiment fastens signage (5) to the rain-gutter with a removable un-threaded rod-piece (7) at the under-side of rain-gutter on the C-clamp. The un-threaded rod-piece (7) is torqued securely to the rain-gutter, which varies contingent on vehicle's make and model (6).

What is claimed:

1: A signage display attachment system for mounting signs to a vehicle, comprised of a C-clamp device that affixes to the vehicle's rain-gutter and the sign's upper grommet holes to support the top of the sign, and as necessary, bungee-cords are hooked and secured through grommet holes across the bottom of the signage and contemporaneously secured to the vehicle's undercarriage.

2: The basic system claimed at claim 1, wherein, a distinguishable C-clamp hanger assembly, is modified to fasten in a similar manner as claim 1, however the connection to the rain-gutter is torqued from the bottom using an un-threaded rod assembly as opposed to screws torqued down from the top.
